(19) United States
(12) Patent Application Publication
(10) Pub. No.: US 2004/0062512 A1
(43) Pub. Date: Apr. 1, 2004

(54) Device for the transmission of optical signals with improved transmission properties

(76) Inventors: Edgar Pawlowski, Rieslingstrasse (DE); Klaus Gerstner, Otto-Hahn-Strasse (DE); Dirk Schlatterbeck, Buchnerstr (DE); Ulrich Peuchert, Ernst-Ludwig-Strasse (DE); Rudiger Sprengard, Georg-Buchner-Strasse (DE); Tobias Kalber, Am Brand 22 (DE); Matthias Brinkmann, Karl-Sieben-Strasse (DE); Marten Walther, Hausener Strasse (DE)

Correspondence Address: M Robert Kestenbaum, 11011 Bermuda Dunes NE, Albuquerque, NM, 87111, US

(21) Appl. No.: 10/415,701

(22) PCT Filed: Nov. 1, 2001
(86) PCT No.: PCT/EP01/12669

(30) Foreign Application Priority Data
Nov. 1, 2000 (WO) PCT/US00/41720
May 1, 2001 (DE) 101 21 204.6
May 1, 2001 (DE) 101 21 203.8

(51) Int. Cl. G02B 6/00; H04B 10/12

(52) U.S. Cl. 385/141; 385/37; 359/337.1

(57) ABSTRACT

So that in the case of a device for transmitting optical signals and having a waveguide with a doped region that comprises a material that is suitable for amplifying optical signals, the signal quality is worsened as little as possible upon traversing this device, it is provided that the doped region has a predefined absorption and that its amplification

The invention relates to a device for transmitting optical signals having at least one waveguide that has a doped region into which a material is introduced that is suitable for amplifying optical signals.

There frequently occur during signal transmission in optical communication and transmission technology absorptions that differ over a prescribed spectral region, or can even change their spectral properties with time. However, it is possible in this case for transmission losses to occur that can frequently no longer be corrected by a simple linear amplification of all spectral regions. Even were it attempted to amplify signals very highly before the transmission, it is possible, in particular, for nonlinear phenomena in excessively strongly amplified spectral regions to lead, in turn, to losses in transmission quality.

EP 0 488 266 B1 describes an optical coupler for a multiplicity of optical fibers, in the case of which coupler an amplifying material is arranged in the vicinity of a cladding or sheath of the waveguide of reduced diameter. Amplification of the optical signals transmitted in the fiber can thereby be performed. The spectral properties of this amplification are, however, dependent on the amplifying material, and thereby permanently fixed for its later application, and cannot ensure optimal conditions for every application.

EP 0 527 265 describes an optical glass fiber amplifier having a first amplifying fiber section inside a fiber with a single-mode core and an optically attenuating device, which are arranged one behind in another in the single propagation direction and have mutually different spectral absorption properties. The aim of this is to permit an amplification inside the glass fiber amplifier that substantially amplifies only signal components. However, it is a disadvantage of this arrangement that because of the arrangement of the amplifying elements in series or one behind another absorbing spectral components are also switched one after another, and so both additional absorptions occur and a lengthening of the transmission path takes place.

EP 0 522 201 teaches influencing the amplification spectrum of a fiber amplifier with a single-mode core by means of an optically attenuating glass fiber device in such a way that the optical power is not substantially influenced in the case of a signal wavelength, but attenuation takes place nevertheless in other spectral regions. However, it is disadvantageous in such fiber amplifiers with single-mode core that it is possible in essence to implement only fixed amplification spectra that cannot be influenced and which cannot take account of instantaneous changes.

In accordance with U.S. Pat. No. 5,993,552 A, attempts have already been undertaken to use a spectrally matched attenuation of input signals of an optical amplifier to generate output signals of the amplifier that have an improved spectral behavior. However, attenuation of input signals generally worsens the signal quality, in particular the bit error rate, and so such concepts are, rather, undesired in the case, for instance, of long range transmission of optical signals, especially when only weak signals are already present. It is also disadvantageous in this mode of procedure that owing to a stronger attenuation of more intense signal components and their subsequently higher amplification all the interference signal components also experience a higher amplification.

Furthermore, optical demultiplexers and multiplexers are key components of optical frequency-division multiplex (OFDM) and wavelength-division multiplex (WDM) communications systems and are described, for example, in W. J. Tomlinson “Wavelength multiplexing in multimode optical fibers”, Appl. Opt. 16, pp. 2180-2194 (1977), in Y. Ishii and T. Kubota “Wavelength demultiplexer in multimode fiber that uses optimized holographic optical elements”, Appl. Opt. 32, pp. 4415-4422, (1993) and in S. Sasaki, K. Sekine and N. Kikuchi “Wavelength division-multiplexing transmission technologies” IOOC'95, ThC3-3, pp. 8081 (1995).

A particularly preferred class of optical signal-transmitting devices comprises Arrayed Waveguide Grating (AWG) structures, which are denoted below for short as AWGs and which are described, for example, in U.S. Pat. No. 5,136,671 A, granted for Dragone, 1992; U.S. Pat. No. 5,243,672 A, granted for Dragone, 1993; U.S. Pat. No. 5,440,416, granted for Colien et al., 1995; M. K. Smit, “New focusing and dispersive planar component based on an optical phased array” Electron. Lett., pp. 385-386, 1988; C. Dragone, “Efficient NxN Star Couplers using Fourier Optics” IEEE J. Lightwave Technol. 7, pp. 479-489, 1989.

It is the object of the invention to provide a device for transmitting optical signals and in the case of which the signal quality is worsened as little as possible during traversal of this device and, in particular, the bit error rate of the transmitted signals is increased as little as possible, which signals can, moreover, be matched with particular flexibility to changing signal conditions such as, for example, the signal intensity and the spectral properties of the signal.

There is, furthermore, the desire to have low-polarization, compact and cost-effective components available in addition to as good a signal transmission as possible.

A particularly advantageous achievement of this object is already achieved with the aid of an optical device having the features of claim 1. A further highly advantageous achievement of this object is produced by a device having the features of claim 8.

A virtually optimal transmission of optical input signals in a wide range of input light intensities, particularly as a function of their spectral properties, can be performed owing to the predefined absorption of the amplifying material of the device in accordance with claim 1. If, for example, one spectral component of an input signal is very weak, by controlling the pump light intensity it is possible without introducing further losses for this signal already to be matched to its input intensity such that the desired intensity is present after amplification without the need for any type of attenuation to occur in the signal intensity.

If another spectral component of an input signal is somewhat stronger, it is possible in this spectral region for a somewhat lesser amplification to be performed, likewise substantially without a worsening of the transmission quality, such as the bit error rate, for example.

If, however, one spectral component of an input signal is already of too strong an intensity for the further transmission path, the amplifying material can produce in the absence, or only the slight presence, of pump light a defined absorption in the case of which fewer noise photons are introduced at the output of the transmission path than in the case of a strong attenuation performed prior to the amplification, as is known from the prior art.

Thus, for example, with the aid of an amplifier as defined in claim 8 it is possible advantageously to implement extreme broadband amplifiers with a response that can be set spectrally with high selectivity.

Preferred values of the absorption without irradiation of pump light are 0.1 to 10 dB/cm, particularly preferred values of the absorption are 0.5 to 5 dB/cm, and the most preferred values of the absorption are 1 to 3 dB/cm.

If, moreover, the waveguide is part of an AWG (Arrayed Waveguide Grating), it is thereby possible also advantageously to influence the spectral properties of the AWG in a selective way and/or for narrowband spectral transmission curves.

In a particularly preferred embodiment, a multiplicity of arms of the AWG have a doped region that in each case comprises a material that is suitable for amplifying optical signals, and the doped regions are respectively assigned a pump light source such that each arm of an AWG can be used independently as amplifying or attenuation element.

A particularly advantageous optical device encompassing a spectrally settable amplification or attenuation is thereby made available.

When each waveguide is assigned a monitor diode that detects the light intensity after at least one part of the doped region, this renders it possible to undertake active control of this transmission path.

It is advantageously possible to set the pump light power on the basis of the light intensity detected by the monitor diode, and output powers or gains of the optical amplification predefined in such a way can be prescribed and implemented.

It is particularly advantageous in this case when the passive glass waveguide arrangement and the active waveguide arrangement are two-dimensional surface waveguide arrangements that are interconnected by means of an LTB method, because freedom from thermal stresses in conjunction with the highest optical quality can thereby be achieved.

When the device for spectral separation is an optical multiplexer constructed in the passive glass waveguide arrangement, it is possible thereby to undertake a very sharp spectral separation of the signal components in a very small space.

The device for combining the amplified optical signals is preferably an optical combiner constructed in the passive glass waveguide arrangement.

In a preferred embodiment, at least one pump laser diode is connected to the passive glass waveguide arrangement and preferably has a wavelength or a wavelength region of 980 nm to 1 480 nm.

The optically amplifying material preferably comprises erbium (Er) and/or a combination of erbium and ytterbium (Er/Yb).

It is particularly advantageous when the length of the amplifying region is of different size for different spectral components of the light to be amplified, because in this way it is possible to compensate a lesser amplification of a specific spectral region by a longer amplification path.

When the site where the pump light is launched differs for different spectral components of the light to be amplified with reference to the optical path length, inside the amplifying material, the effective interaction length of the pump light with the light to be amplified can be set optimally or in a predefined way.

The amplification spectrum can be markedly expanded given more than one doped region and more than one optically amplifying material.

It is particularly advantageous when at least one pump laser diode is connected to the passive glass waveguide arrangement, which feeds pump light in the direction of propagation of the light to be amplified, and at least one pump laser diode is connected to the passive glass waveguide arrangement, which feeds pump light opposite to the direction of propagation of the light to be amplified, because it is then possible to achieve a particularly effective launching of the pump light in the case of which scattering losses in the waveguide can be avoided.

The invention is described below with the aid of the attached drawings and with reference to preferred exemplary embodiments.

In the drawings:

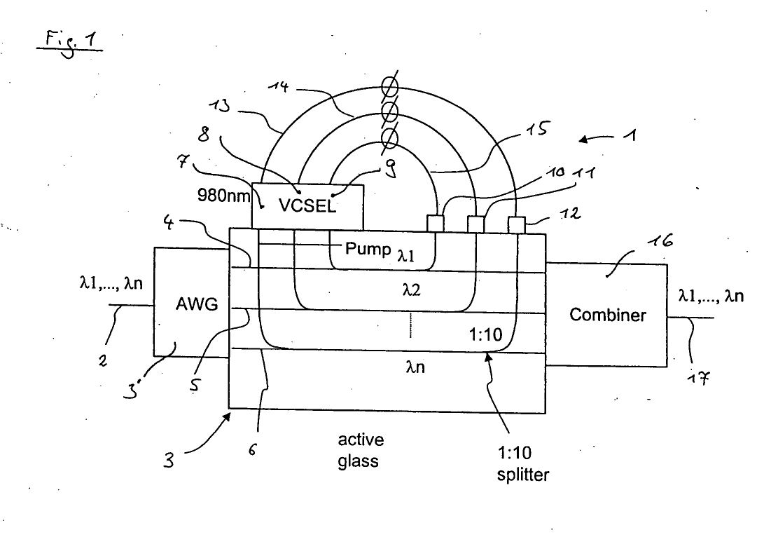

FIG. 1 shows a first device according to the invention for transmitting optical signals in the form of an optical module with variable amplification and attenuation,

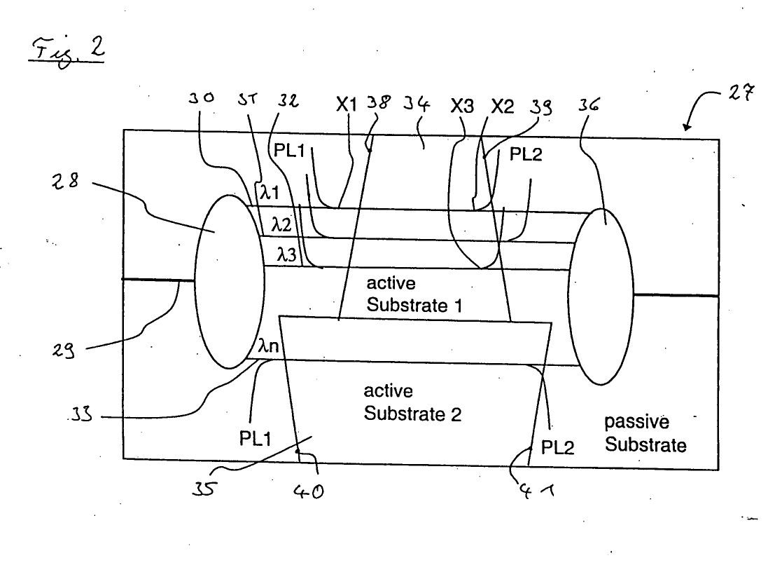

FIG. 2 shows a second device according to the invention for transmitting optical signals in the form of a broadband optical amplifier, in particular in the form of a broadband optical amplifier with spectrally adapted amplification properties,

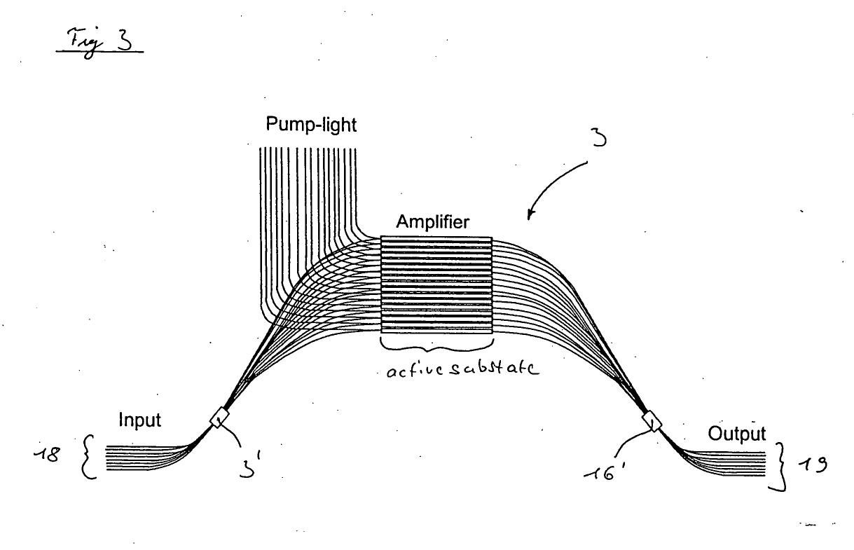

FIG. 3 shows a schematic illustrated further device according to the invention for transmitting optical signals in the form of an AWG, in particular in the form of an AWG with spectrally adapted amplification properties, as a further development of the embodiment illustrated in FIG. 1,

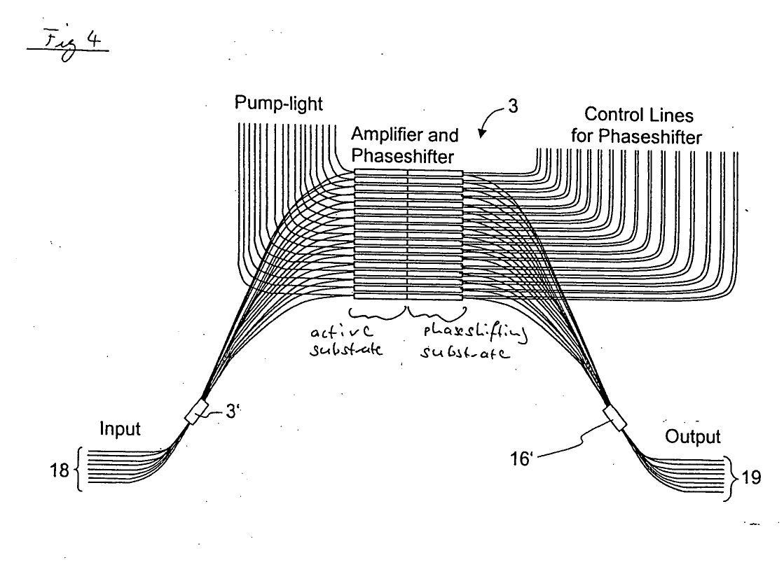

FIG. 4 shows a schematically illustrated, yet further device according to the invention for transmitting optical signals in the form of an AWG, in particular in the form of an AWG with spectrally adapted amplification properties and spectrally separated phase-modulating or phase-shifting devices, as a further development of the embodiment illustrated in FIG. 1,

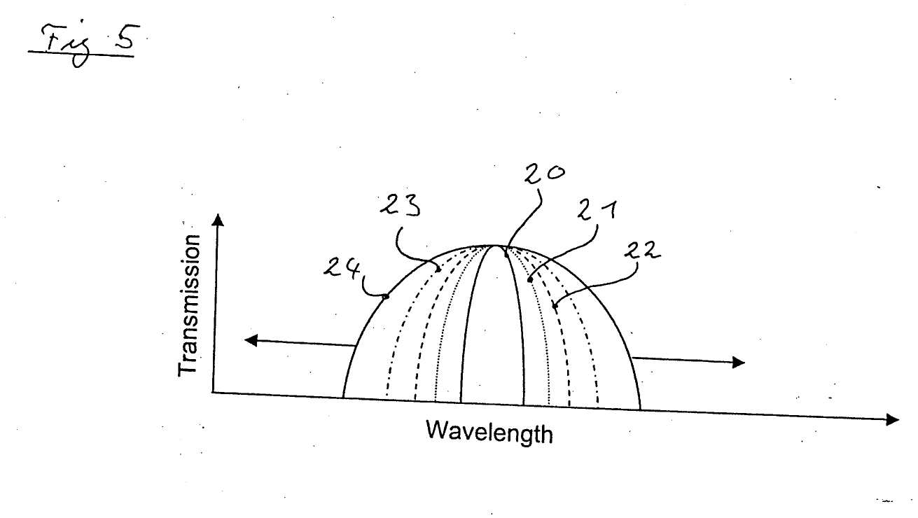

FIG. 5 shows a schematic of the influence of the amplification within the arms of the AWG illustrated in FIG. 3 on the spectral width of the transmitted signals, and

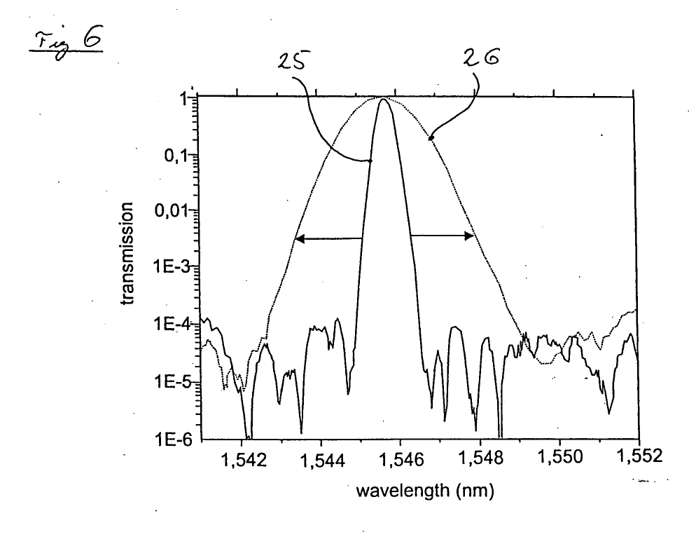

FIG. 6 shows a more exact calculation of the spectral width of the signals, transmitted in the AWG illustrated in FIG. 3, for 20 arms of the AWG, illustrated as a dotted line, and for 80 arms of the AWG, illustrated as a continuous line.

### DETAILED DESCRIPTION OF PREFERRED EMBODIMENTS

The invention is described below in more detail with the aid of preferred exemplary embodiments, and reference is made firstly to FIG. 1, which shows a first device according to the invention for transmitting optical signals in the form of an optical module with variable amplification and attenuation.

The module illustrated in FIG. 1 and provided overall with the reference 1 comprises an optical AWG (Arrayed Waveguide Grating), as the latter is described, for example, in more detail in DE 101 12 331 or DE 101 12 349, the contents of which are rendered in their entirety the subject matter of the present application.

An optical signal is fed in the signal fiber 2 to a free-beam region 3′ of an AWG 3 whose individual arms 4, 5, 6, of which only three are illustrated by way of example in the drawing, have at least in each case one section that is doped with an amplifying material such as, for example, a rare earth material; this region is denoted in FIG. 1 by way of example as active glass and constructed in an otherwise substantially transparent substrate or support material.

Owing to the amplification possible according to the invention, the number of the arms of the AWG, and thus the spectral resolution of the latter, can be very high. It is within the scope of the invention to provide AWGs with more than 100 arms, with more than 400 arms and, in particular, with more than 1 000 arms. Each normal whole number of arms n≦10 000 can be selected and implemented as a function of the spectral resolution desired. Use may be made in this case of lithographic techniques for structuring the waveguides in the surface of the support material. The adaptation of the free-beam region 3′ to this desired number of the arms is possible to an expert in this field with the aid of his expert knowledge.

It is also within the scope of the invention to use as amplifying materials tellurite glasses, antimony-containing glasses, bismuth-containing or bismuthate glasses as well as oxidic glasses made from these compounds.

In the preferred embodiment, the arms of the AWG 3, and the free-beam region 3′ of the AWG 3 are constructed inside a two-dimensional substrate, and the optical components of the system, or at least some of these components are interconnected with the aid of an LTB (Low Temperature Bonding) method, as is described in PCT US 00/41720 and PCT US 00/41721 as well as their applications establishing priority, the entire contents of all of which are rendered the subject matter of the present description by reference.

The substrate in which the waveguides are constructed can consist of glass, silica glass, silicon, a semiconductor material such as, for example, indium or gallium arsenide, or can also consist of a plastic, for example a polycarbonate material, and is not restricted to specific support materials.

A dedicated pump laser diode 7, 8, 9 whose intensity can be independently controlled is respectively connected to preferably each arm 4, 5, 6 of the AWG 3.

It is preferred to assign each pump laser diode 7, 8, 9 a dedicated monitor diode or photodiode 10, 11, 12, which receives light from the respective arm 4, 5, 6, the pump laser diodes 7, 8, 9 being illustrated in FIG. 1 as a single monolithic block, and being able to be implemented together with their electronic drive on a common semiconductor substrate.

The light received from the respective arm 4, 5, 6 is preferably greatly reduced in intensity by a dielectric beam splitter such that the losses thereby produced remain minimal. Preferred splitter ratios of the beam splitter are 1 to 10, preferably 1 to 100 or, even more strongly preferred, 1 to 1 000 or more than 1 to 10 000.

In order to control the light intensity of the pump laser diodes 7, 8, 9, there are connected downstream of the photodiodes 10, 11, 12 in each case electronic amplification paths 13, 14, 15, each independently having a settable amplification.

Furthermore, the absolute light intensity of the pump laser diodes 7, 8, 9, which are preferably constructed as VCSEL (Vertical Cavity Surface emitting Laser) can also be set by external means (not illustrated in the drawings), such that it is possible to implement fixed, preset spectral amplification profiles that can be retrieved electronically.

Consequently, each of the arms 4, 5, 6 of the AWG 3 has an independently controlled or permanently settable amplification.

The light of the arms 4, 5, 6 is brought together in a coupler or combiner 16 and launched into an output optical fiber 17.

The combiner 16 can comprise a two-dimensional waveguide coupler such as is known to a person skilled in the art in the present field.

Owing to the doping with the amplifying material, each of the arms 4, 5, 6 has a prescribable absorption, dependent on the doping concentration, and thus a settable optical attenuation when the amplification achieved by the amplifying material is smaller for a low pump light than the attenuation of the material.

It is within the scope of the invention, moreover, also to introduce additional substances or mixtures into the amplifying region, in order, for example, to obtain an absorption curve defined in accordance with a desired spectrum, or to adapt the spectral amplification properties to the arm of the AWG respectively present.

The amplification can become greater than the attenuation if the pump light power increases. As a result, attenuation and amplification values can be set independently for each arm 4, 5, 6 of the AWG 3 so as to produce a spectral transmission characteristic of the optical module that reaches in each spectral region from a prescribable attenuation up to amplification.

FIG. 3 shows a schematic of an AWG 3 with eight input signal waveguides, n=8, that can, for example, comprise eight signal channels with in each case m spectrally adjacent optical signals at wavelengths λ1, λ2, λ3, . . . λm in each of these optical signals.

These signals are fed through the free-beam region 3′ to the individual arms, whose number is illustrated only schematically in FIG. 3 with 17 arms, and the light propagating in these arms, which is, as described above, launched into the pump light in a way known to the person skilled in the art with the aid, in each case, of one region of the amplifying material, is optically amplified. Each arm of the AWG 3 in this case has a dedicated amplifier, denoted by amplifier in FIG. 3, that permits independent setting of the amplification or attenuation of the light propagating in the same, and which is situated in the region denoted by active substrate.

After the light has traversed the arms of the AWG 3 and been amplified or attenuated therein, the light of these arms is projected inside the free-beam region 16′ onto m spectrally adjacent output waveguides 19 and launched into the latter.

Without limitation of generality, the number m also has the value eight in FIG. 3, but the invention is not limited to the equality of n and m.

This embodiment according to the invention is outstandingly suited for operation as a frequency demultiplexer with variable amplification and attenuation, as well as with variable spectral transmission properties, in the case of which the eight spectral components of each input signal with the wavelengths λ1, λ2, λ3, . . . λm can be launched into the eight output waveguides 19 in a spectrally separate fashion.

The variability of the spectral width of the transmission function is illustrated schematically in FIG. 5 and in a more exactly calculated fashion in FIG. 6. The narrow, continuously represented spectral transmission curve 20 is realized if all arms are amplified.

If some of the arms of the AWG 3 are “switched off” by high absorption or attenuation, or if they have signal intensities that are still only negligible, the spectral transmission curve expands to the curve provided with the reference numeral 21.

Around this high attenuation, which equates to shutting down, the selection of the doping density of the active material and/or the additional introduction of absorbing substances with a selectable absorption spectrum such as, for example, dyes, result in values of the absorption within the amplifying region without irradiation of pump light which are 0.1 to 10 dB/cm, with particular preference 0.5 to 5 dB/cm and with most preference 1 to 3 dB/cm, whereas otherwise the aim is a transmission that is as free from absorption as possible in the remaining transmission regions.

With decreasing number of transmitting arms, the spectral transmission curves illustrated at 22, 23 and 24 are subsequently implemented, and it is thereby possible to provide a filter with a variable spectral width, as is very valuable for many optical applications.

For example, by means of such filters it is possible to relocate from a first spectral channel spacing to a second spectral channel spacing, for example, to transfer signals spaced apart at 200 GHz into a channel spacing with 100 GHz. The number of the arms of the AWG 3 can be increased by the amplification in its arms, and thus the spectral finesse thereof can be improved.

Furthermore, the spectral shape of laser signals can also be optimized in each case as regards their spectral characteristic and intensity, in accordance with application.

FIG. 6 shows the more exactly calculated spectral transmission curves for a losslessly operated AWG 3 with the transmission curve 25 for operation with 80 losslessly transmitting arms and with the transmission curve 26 for operation with 20 losslessly transmitting arms of the AWG 3.

A development of the AWG 3 from FIG. 3 is illustrated in FIG. 4, and in this case each waveguide, which comprises an amplifying region, that is to say an active region, also contains a region that can be modulated in this phase. Only by way of example, in FIG. 4 the region of the phase modulator, also denoted as phase shifting substrate, is arranged downstream of the active region as seen in the signal propagation direction. This region can likewise be arranged upstream of the amplifying region.

The phase modulator has a material whose effective refractive index can be changed, for example a thermooptic or an electrooptic material such as LiNbO₃, for example. The change in the effective refractive index results in a change in the optical path length within the respective arm of the AWG 3, which can also be represented as a phase shift of the optical signal propagating in this arm, for which reason the phase modulator is also denoted as a phase shifter.

Each phase modulator or phase shifter of each arm of the AWG 3 has a dedicated connecting line to the assigned electronic control system, this connecting line being illustrated merely schematically as control lines for phase shifter in FIG. 4.

By driving the phase modulators or phase shifters appropriately, it is possible to compensate a phase shift occurring during the amplification, or to compensate component-induced fluctuations in the length of the arms of the AWG 3 in an active fashion, for example with the aid of a known reference signal and its spectral detection by the assigned electronic control system (not illustrated in figures, however). Furthermore, it is also possible thereby to compensate thermally induced fluctuations.

Such optical modules can generally be used advantageously in telecommunications systems in order to improve their transmission characteristics substantially, in particular in order to adapt the latter to desired spectral intensity stipulations for downstream optical signal transmitting and/or processing devices.

Reference is made to FIG. 2, which shows a broadband optical amplifier, in the following description of the second exemplary embodiment according to the invention.

A broadband optical amplifier is described, for example, in PCT US 00/41720, the entire content of which is rendered the subject matter of the present description by reference.

The broadband optical amplifier, which is provided overall with the reference numeral 27 and illustrated in FIG. 2, comprises a device 28 for spectral separation, for example an AWG, a beam splitter system with various narrowband filters or a prism, for spectral separation of optical input signals, to which an input waveguide 29 feeds optical signals with different spectral positions or regions λ1, λ2, λ3, . . . λn.

After their spectral separation, these spectral components λ1, λ2, λ3, . . . λn are respectively fed to dedicated assigned waveguides 30, 31, 32, 33 that each have at least one section 34, 35 with optically amplifying material 20.

After the section with amplifying material, the waveguides 30, 31, 32, 33 conduct the amplified light to a device for uniting the amplified optical signals (combiner) 36.

The individual components, set forth above, of the amplifier 27 are preferably interconnected with the aid of an LTB method if they are implemented on more than one optical substrate. The description of this LTB method was also incorporated here completely by reference above.

The region with amplifying material defines an active waveguide arrangement that has the doped region inside which an optically amplifying material is arranged in each case, and the waveguides 30, 31, 32, 33 respectively define outside the active region, which are denoted as active substrate 1 and as active substrate 2, conventional two-dimensional waveguides arranged in the surface of an optical substrate.

In the embodiment most preferred, the device 28 for spectral separation is an optical multiplexer, for example an AWG, constructed in the passive glass waveguide arrangement, and the device for uniting the amplified optical signals (combiner) is an optical combiner, for example a waveguide coupler, constructed in the passive glass waveguide arrangement.

A pump laser diode PL1 is respectively connected individually to each of the waveguides 21, 22, 23, 24 of the passive glass waveguide arrangement, and preferably has a wavelength of 980 nm or 1 480 nm, or emits in broadband fashion over this entire wavelength region from 980 nm to 1 480 nm, the optically amplifying material comprising a rare earth element or a mixture of rare earth elements, preferably erbium (Er) and/or a combination of erbium and ytterbium (Er/Yb).

The pump laser diode PL1 feeds pump light in the propagation direction of the light to be amplified.

In a simplified form of the invention, the pump laser diode feeds all the waveguides 21, 22, 23. In this case, the further measures described below for spectrally influencing the amplification are particularly advantageous, but they are not limited to this embodiment.

The length of the amplifying region is of different size for different spectral components of the light to be amplified, which means that the length over which pump light is made available is of different size for the different spectral components λ1, λ2, λ3, . . . λn.

This is indicated schematically in the attached drawing by the trapezoidal shape of the active region (active substrate 1 and active substrate 2) in a schematic fashion with the lines 38, 39, 40, 41 bounding this region.

This change in length of the amplifying material is not, however, limited to linear or trapezoidal changes, but can be freely selected essentially for any spectral component λ1, λ2, λ3, . . . λn.

It is possible thereby, for example, for the respective length of the amplifying path of the waveguides 30, 31, 32, 34 to be selected inversely relative to the spectral amplification of the amplifying material within the active substrate 1 and the active substrate 2, in order to provide a spectrally constant amplification function, or to have lengths adapted to spectral losses of a transmission system.

Moreover, the waveguides 30, 31, 32, 34 can also be arranged non-equidistantly, such that even in the case of trapezoidal amplifying regions of active substrate 1 and active substrate 2 it is possible, as a function of the internal angles of the limbs of the trapezoids and the spacing of the waveguides 30, 31, 32, 34, to realize amplification profiles that can be predetermined spectrally virtually arbitrarily.

Furthermore, it is possible by using photolithographic masking and surface finishing techniques to introduce into the waveguides 30, 31, 32, 34 amplifying materials with virtually arbitrary geometries for the amplifying region of the active substrate 1 and the active substrate 2.

Moreover, the site of the launching X1, X2, X3 of the pump light PL1, PL2 for different spectral components of the light to be amplified can be selected variously with reference to the optical path length covered inside the amplifying material such that it is also possible thereby for an effective interaction length to be set spectrally between the pump light and light to be amplified.

In the case of preferred embodiment, more than one doped region of active substrate 1 or active substrate 2 exists, and more than one optically amplifying material is doped in for the purpose of improvement, in order to support the broadbandness of the amplifier. Thus, for example, the waveguides 21, 22, 23, 24 can in each case comprise various spectrally optimized active materials, or a plurality of waveguides can respectively have the same active material owing to their adapted interaction length of the light to be amplified with the pump light.

In addition to the at least one pump laser diode PL1, which feeds pump light in the propagation direction of the light to be amplified, the most preferred embodiment comprises at least one further pump laser diode PL2, which is connected to the passive glass waveguide arrangement and which feeds pump light in the opposite direction to that of propagation of the light to be amplified.

It is possible with the aid of the measures described above to implement a highly broadband amplifier of highest optical quality.

It is, moreover, possible to produce predefined spectral amplification profiles that respectively have inside the waveguides 30, 31, 32, 34 i) materials, ii) interaction lengths of pump light and light to be amplified, and/or iii) launch sites, assigned to the waveguides 21, 22, 23, 24, of the pump light that correspond to the desired amplification.

In the preferred embodiment, the individual components of the amplifier are interconnected with the aid of an LTB (low temperature bonding) method, as is entirely rendered the subject matter of the present description by reference.

1. A device for transmitting optical signals, comprising at least one waveguide with a doped region containing a material that is suitable for amplifying optical signals, in the case of which the doped region has a predefined absorption and whose gain can be changed by irradiating pump light, and further comprising a device for separating spectral components of optical signals, in which the waveguide is assigned a monitor diode that detects the light intensity after the light has traversed at least one part of the doped region.

2. The device for transmitting optical signals as claimed in claim 1, wherein the waveguide is part of an AWG (Arrayed Waveguide Grating).

3. The device for transmitting optical signals as claimed in claim 1 or 2, wherein the doped region of the waveguide is assigned at least one pump light source.

4. The device for transmitting optical signals as claimed in claim 2 or 3, wherein a multiplicity of arms of the AWG have a doped region that in each case comprises a material that is suitable for amplifying optical signals, and wherein the doped region is respectively assigned a pump light source.

5. The device for transmitting optical signals as claimed in one of the preceding claims, wherein the pump light power can be set on the basis of the light intensity detected by the monitor diode.

6. The device for transmitting optical signals as claimed in one of the preceding claims, wherein without irradiation of pump light the absorption in the region of the material that is suitable for amplifying optical signals is preferably 0.1 to 10 dB/cm, particularly preferably 0.5 to 5 dB/cm, and most preferably 1 to 3 dB/cm.

7. The device for transmitting optical signals, in particular as claimed in one of the preceding claims, in particular an optical amplifier with broadband amplification, comprising a device for spectral separation of optical signals, at least one waveguide that receives spectral components of an optical signal from the device for spectral separation of optical signals, at least one section with an optically amplifying material having predefined absorption of the amplifying material that is arranged in the at least one waveguide, and a device for combining the amplified optical signals.

8. The device as claimed in claim 7, in particular an optical amplifier, wherein components of the device for transmitting optical signals are interconnected with the aid of an LTB method (Low-Temperature Bonding method).

9. The device as claimed in claim 7 or 8, in particular an optical amplifier, wherein the optical amplifier comprises a passive glass waveguide arrangement and an active waveguide arrangement that has a doped region inside which an optically amplifying material is arranged.

10. The device as claimed in one of claims 7 to 9, in particular an optical amplifier wherein the at least one waveguide and, in particular, the passive glass waveguide arrangement and the active waveguide arrangement are two-dimensional surface waveguide arrangements.

11. The device as claimed in one of claims 7 to 10, in particular an optical amplifier, wherein the device for spectral separation is an optical demultiplexer, constructed in the passive glass waveguide arrangement, in particular a grating or an AWG.

12. The device as claimed in one of the preceding claims 7 to 11, in particular an optical amplifier, wherein the device for combining the amplified optical signals is an optical combiner or multiplexer constructed in the passive glass waveguide arrangement.

13. The device as claimed in one of the preceding claims, in particular an optical amplifier, wherein at least one pump laser diode is connected to the passive glass waveguide arrangement, which preferably has a wavelength of 980 nm or 1 480 nm.

14. The device as claimed in one of the preceding claims, in particular an optical amplifier, wherein the optically amplifying material comprises erbium (Er) and/or a combination of erbium and ytterbium (Er/Yb).

15. The device as claimed in one of the preceding claims, wherein the optically amplifying material contains tellurite glasses, antimony-containing glasses, bismuth-containing or bismuthate glasses as well as oxidic glasses from these compounds.

16. The device as claimed in one of the preceding claims, in particular an optical amplifier, wherein the length of the amplifying region is of different size for different spectral components of the light to be amplified.

17. The device as claimed in one of the preceding claims, in particular an optical amplifier, wherein the site where the pump light is launched differs for different spectral components of the light to be amplified with reference to the optical path length inside the amplifying material.

18. The device as claimed in one of the preceding claims, in particular an optical amplifier, defined by more than one doped region and more than one optically amplifying material.

19. The device as claimed in claim 13, in particular an optical amplifier, wherein at least one pump laser diode is connected to the passive glass waveguide arrangement, which feeds pump light in the direction of propagation of the light to be amplified, and at least one pump laser diode is connected to the passive glass waveguide arrangement, which feeds pump light opposite to the direction of propagation of the light to be amplified.

20. The device as claimed in one of the preceding claims, wherein the at least one waveguide contains a phase modulator or phase shifter.

21. The device as claimed in claim 20, wherein the phase modulator or phase shifter of each waveguide can be driven separately from the phase modulators or phase shifters of other waveguides.

22. The device as claimed in claim 20 or 21, wherein the phase modulator or phase shifter comprises a thermooptic modulator.

23. The device as claimed in one of claims 20 to 22, wherein the phase modulator or phase shifter comprises an LiNbO₃ modulator.

24. A device for controlling the intensity, the phase angle and/or the spectral width of an optical signal, comprising a device for transmitting optical signals as claimed in one of claims 1 to 23.

25. A method for transmitting optical signals, in particular in a device as claimed in one of the preceding claims, having at least one waveguide with a doped region containing a material that is suitable for for amplifying optical signals, and which has a predefined absorption,
in which spectral components of optical signals are separated, and
in which a spectral component is amplified as a function of its input light intensity in the doped region having predefined absorption by changing the pump light intensity or is attenuated by producing a defined absorption.

26. The method as claimed in claim 25, in which the at least one waveguide is assigned a monitor diode, wherein the light intensity is detected by the monitor diode after at least a part of the doped region.

27. The method as claimed in claim 26, wherein an active regulation of the amplification is undertaken.

28. The method as claimed in claim 26 or 27, wherein the pump light power is set on the basis of the light intensity detected by the monitor diode.

29. The method as claimed in one of claims 25 to 28, wherein the amplified or attenuated optical signals are combined.

30. The method as claimed in one of claims 25 to 29, wherein the spectral components of optical signals are separated with the aid of an optical demultiplexer, in particular a grating or an AWG, constructed in a passive glass waveguide arrangement.

31. The method as claimed in one of claims 25 to 30, wherein the pump light for different spectral components of the light to be amplified is launched at different sites with reference to the optical path length covered inside the amplifying material.

32. The method as claimed in one of claims 25 to 30, wherein the phase of the spectral component is modulated.
